(19) United States
(12) Patent Application Publication
(10) Pub. No.: US 2002/0142117 A1
(43) Pub. Date: Oct. 3, 2002

(54) Balloon with four aluminous foil leaves and a fabricating method thereof

(76) Inventor: San Yu Huang, Taipei (TW)

Correspondence Address: Dougherty & Troxell, ONE SKYLINE PLACE, 5205 LEESBURG PIKE, SUITE 1404, FALLS CHURCH, VA, 22041, US

(21) Appl. No.: 09/820,909

(22) Filed: Mar. 30, 2001

(51) Int. Cl. B32B 1/02

(52) U.S. Cl. 428/35.3; 428/35.5; 428/35.2

(57) ABSTRACT

A balloon with four aluminum foil leaves comprises a first sheet piece, a second sheet piece, a third sheet piece, and a fourth sheet piece. Each sheet piece is made of polymer film, and a respective surface thereof is added with polyethylene lamination. The fourth sheet piece is disposed to be opposite to the first sheet piece in a way that the polyethylene laminations thereof facing to each other. The second sheet piece and the third sheet piece are folded in two halves respectively to expose polyethylene laminations thereof and are disposed oppositely between the first and the fourth sheet pieces in a way that the polyethylene laminations thereof face to the first and the fourth sheet pieces. As soon as the sheet pieces are overlapped to one another, an oval shape is formed with an elongated open end and then the overlapped sheet pieces are press-heated by a molding tool. Thus, the polyethylene laminations are heated up and melted to join together and the folded ports of the second and the third sheet pieces expand outward as a curved surface of sphere while the air is filled in through the elongated open end.

### BACKGROUND OF THE INVENTION

1. Field of The Invention

The present invention relates to a balloon with four aluminum foil leaves and a fabricating method thereof, and more particularly to a way to form a balloon of aluminum foil leaves, with which the balloon made is much more closer to a true spherical shape than the conventional known balloon with two aluminous foil leaves. In addition, the balloon of aluminous foil is referred to the balloon is made of nylon or polyester film with an outer surface thereof being evaporated with aluminum foil or without evaporation of aluminum foil.

2. Description of Related Art

It is known that the balloon with aluminum foil is a conventional product, which has been developed for a long period of time. Because of having been treated with evaporation, the balloon provides an appearance thereof with a luster of metal. Moreover, the balloon with aluminum foil is much more durable than rubber balloon. Thus, the balloon with aluminum foil is often used during festivals to cheer up the joyous air.

The conventional balloon with two aluminum foil leaves is made of two polymer films facing to each other and being press-heated by way of a molding tool. Thus, the polymer films can be melted in a way of joining together. Due to being formed an oval joining line, the upper and the lower pieces of the joined polymer films provide no expanded space so that it is hard for the balloon to form a spherical shape after the air having been filled. Undesirably, it always results in a cone shape or a pumpkin shape for the balloon instead depending on the configuration of the molding tool. This is the reason why the conventional balloon with two aluminum foil leaves cannot be made so round as the rubber balloon.

### SUMMARY OF THE INVENTION

The object of the present invention to provide a balloon with four aluminum foil leaves and a fabricating method thereof with which the balloon made can obtain a shape much closer to a true sphere effectively.

### BRIEF DESCRIPTION OF THE DRAWINGS

The present invention can be more fully understood by referring to the following description and accompanying drawing, in which:

FIG. 1 is a perspective view of sheet pieces arranged for a balloon with four aluminum foil leaves according to the present invention;

FIG. 2 is a perspective view illustrating the sheet pieces shown in FIG. 1 being treated by mold pressing; and

FIG. 3 is top view of a finished product of a balloon with four aluminum foil leaves according to the present invention.

### DETAILED DESCRIPTION OF THE PREFERRED EMBODIMENTS

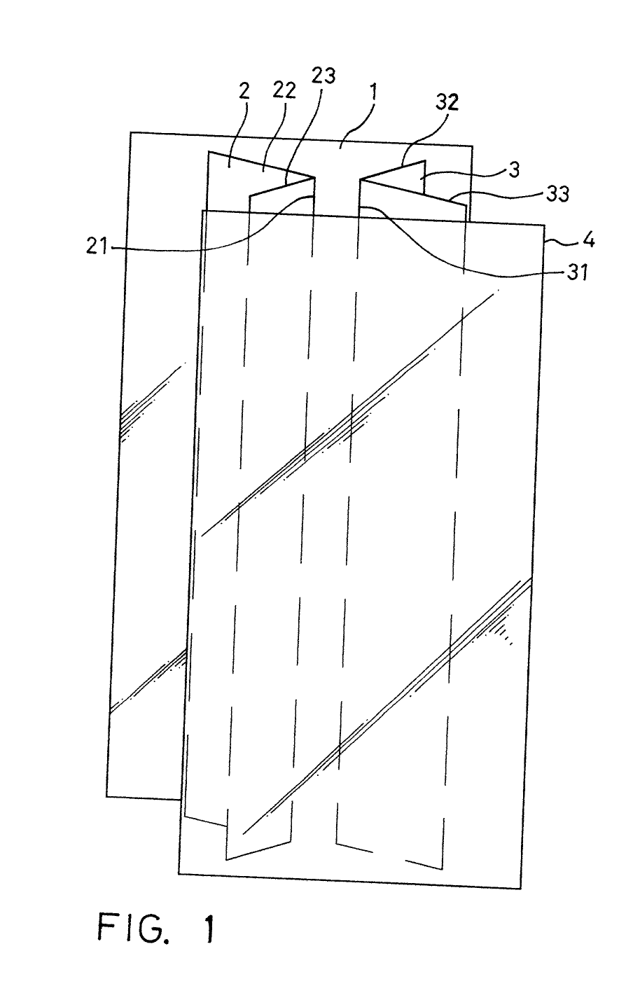

Referring to FIGS. 1, 2, and 3, a balloon with four aluminum foil leaves of the present invention basically is fabricated by way of four pieces of aluminum foil, which are designated as the first sheet piece 1, the second sheet piece 2, the third sheet piece 3, and the fourth sheet piece 4, respectively. Each sheet piece is made of polymer such as nylon or polyester being evaporated at a surface thereof with aluminum foil or without being evaporated with aluminum foil so that a surface thereof is provided with an aluminum foil and the other surface thereof is the original polymer surface or both surfaces thereof are polymer surfaces. The first sheet piece 1 and the fourth sheet piece 4 are disposed at the front and the rear outer most positions. The second sheet piece 2 and the third sheet piece 3, which have been folded as two halves so that a central folded lines 21, 31 are left on the second sheet piece 2 and the third sheet piece 3, constitute two sheet piece halves respectively by way of being separated by the folded lines 21, 31. That is, a second front portion 22 of second sheet piece 2 and a second rear portion 23 of second sheet piece 2 are formed due to the folded line 21, and a front half portion 32 and a rear half portion 33 of third sheet piece 3 are formed due to the folded line 31. The second sheet piece 2 and the third sheet piece 3 are arranged to have their folded lines 21, 31 being disposed facing to each other with respect to the central position.

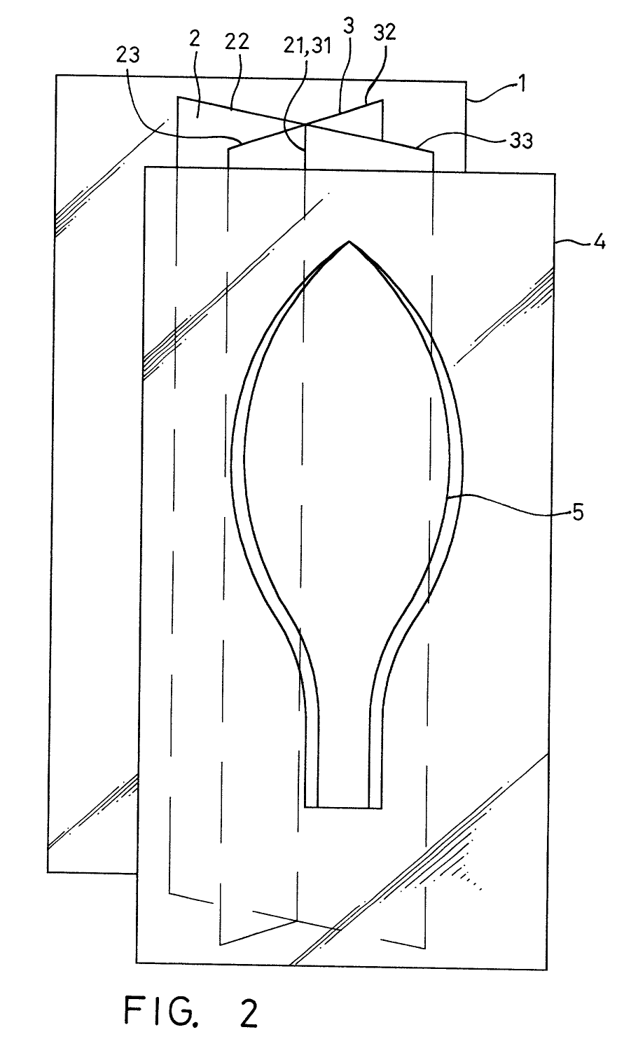

In order to join all the four sheet pieces by way of heat melting, all adjacent surfaces, i.e., the inner surface of first sheet piece 1, a surface on the front half portion 22 adjacent the inner surface of first sheet piece 1, a surface on the second rear portion 23 adjacent the inner surface of fourth sheet piece 4, a surface on the third front portion 23 adjacent the inner surface of first sheet piece 1, a surface on the third rear portion 33 adjacent the inner surface of fourth sheet piece 4 are added a polyethylene lamination. Then, a molding tool 5 as shown in FIG. 2 is applied to perform a heat pressing, and the molding tool is an oval frame mold with a specific length. The molding tool 5 has an intersection end and the other end thereof is an open end with an appropriate length to form an air inlet.

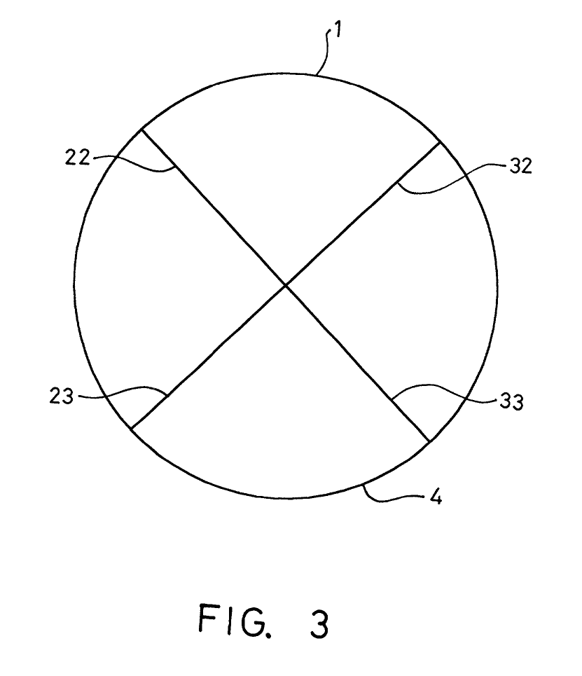

After being heated and pressed by the molding tool 5, contact surfaces with polyethylene lamination form melted joint. Next, the redundant part outside the folding lines is removed and it is possible to obtain a folded oval shape work piece. As soon as the air is blown into the folded oval work piece, an aluminum foil balloon of spherical shape as shown in FIG. 3 can be obtained. That is, the balloon obtained is a round balloon on which the outer surface, which is composed of first sheet piece 1, the second sheet piece 2, the third sheet piece 3, and the fourth sheet piece 4, are aluminum foils.

In order to obtain a balloon with four aluminum foil leaves of present invention, the fabricating way thereof comprises (A) a step of material preparation; (B) a step of material arrangement; (C) a step of press-forming; and (D) a step of removing redundant part. A detail with regard to the steps of making the balloon of present invention will be described hereinafter.

The step of material preparation is that four aluminum foil leaves, i.e., the preceding first, the second, the third, and the fourth sheet pieces 1, 2, 3, and 4 are picked. The non-evaporated surface of each sheet piece, i.e., the polymer surface is added with the polyethylene lamination first. Then, the second and the third sheet pieces 2, 3 are folded into two halves respectively in a way that the polyethylene laminations thereof face outward oppositely and the evaporated surfaces thereof face inward to each other.

The step of material arrangement is that the first sheet piece 1 and the fourth sheet piece 4 are disposed at the outer most positions and the folded second sheet piece 2 and the folded third sheet piece 3 are disposed at the central position between the first sheet piece 1 and the fourth sheet piece 4. The respective polyethylene lamination on the second sheet piece 2 and the third sheet piece 3 face the first and the fourth sheet pieces with the folded lines facing to each other as closer as possible. The arrangement makes the second sheet piece 2 and the third sheet piece 3 being intermediate layers, and the first and the fourth sheet pieces being at two lateral sides.

The step of press-forming is to adopt a molding tool which has an oval closed frame with a specific width and provides an open end as an air inlet. The molding tool is associated with a heating device such that the molding tool can reach a melting temperature for the polyethylene lamination to press the multiple pieces of sheet materials arranged in the step of material arrangement. Thus, the respective part of each sheet piece corresponding to the frame of molding tool is melted to join one another.

The step of removing redundant part is to remove the material outside the mold frame after the respective layer of material has been pressed such that an oval finish product is formed. As soon as the air is blown into the finish product, a balloon with spherical shape is obtained.

It can be understood from the preceding embodiment that the present invention can provide a balloon, which is much more close to spherical shape than the conventional balloon with two aluminum foil leaves. In addition, the present invention has overcome the bottleneck and the obstacle during making a round aluminum foil balloon.

While the invention has been described with reference to a preferred embodiment thereof, it is to be understood that modifications or variations may be easily made without departing from the spirit of this invention, which is defined by the appended claims.

What is claimed is:

1. A balloon with four aluminous leaf foils, comprising:
a first sheet piece with an inner surface, being a polymer film, the inner surface thereof being added with polyethylene lamination;
a fourth sheet piece with an inner surface, being a polymer film, the inner surface thereof being added with polyethylene lamination and being disposed facing the inner surface of said first sheet material;
a second sheet piece with two surfaces, being a polymer film and having a folded part, one of said two surfaces thereof being added with polyethylene lamination, being disposed between respective inner surface of the first and the fourth sheet pieces and forming a one half width;
a third sheet piece with two surfaces, being a polymer film and having a folded part, one of said two surfaces thereof being added with polyethylene lamination, being disposed between the first and the fourth sheet pieces with the polyethylene lamination thereof facing the respective inner surface of the first and the fourth sheet pieces, and forming another one half width thereof opposite to the second sheet piece;
whereby, as soon as the sheet pieces being overlapped together, an oval shape is constituted with an elongated open end so as to be press-heated and the heated polyethylene laminations are melted to join together and the folded parts of the second and the third sheet sheets expand outward as a curved surface of sphere.

2. The balloon with four aluminous foil leaves according to claim 1, wherein the polymer preferably is nylon or polyester.

3. The balloon with four aluminous foil leaves according to claim 1, wherein a surface with non-polyethylene lamination on the respective sheet piece may be evaporated with aluminum foil.

4. A fabricating method of balloon with four aluminous leaf foils, comprising:
(A) a step of material preparation: picking four pieces of polymer films, adding a polyethylene lamination on a surface of the respective polymer film, two of said four polymer films being folded with the polyethylene lamination exposing outward;
(B) a step of material arrangement: another two of the preceding four polymer films being disposed oppositely to each other in a way of sandwiching the other two polymer films and a respective surface without polyethylene lamination on said another two polymer films facing outward, and each of said two sheet pieces occupying one half width;
(C) a step of press-forming: a molding tool, which having an oval heated mold frame with a width and an end thereof being opened to form an air inlet, pressing the overlapped sheet pieces obtained in the step of material arrangement, the polyethylene laminations on the overlapped sheet pieces corresponding to the mold frame being melted and join together;
(D) a step of removing redundant material, the redundant material outside the mold frame being removed such that the pressed and joined sheet pieces expanding outward along the folded parts thereof to form a curved surface of sphere in case of being filling with air.

5. The fabricating method of balloon with four aluminous leaf foils according to claim 4, wherein the polymer preferably is nylon or polyester.

6. The fabricating method of balloon with four aluminous leaf foils according to claim 4, wherein a surface with non-polyethylene lamination on the respective sheet piece may be evaporated with aluminum foil.
